(19) United States
(12) Patent Application Publication
(10) Pub. No.: US 2006/0143150 A1
(43) Pub. Date: Jun. 29, 2006

(54) Messaging system and method of operation thereof

(75) Inventors: Stephen James Hobson, Hampton (GB); Stewart Laundon Palmer, New York, NY (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/291,734

(22) Filed: Dec. 1, 2005

(30) Foreign Application Priority Data
Dec. 15, 2004 (GB) 0427547.5

(51) Int. Cl. G06F 17/30

(52) U.S. Cl. 707/1

(57) ABSTRACT

A method of operating a messaging system comprising receiving a message, creating a list element for the message, the list element comprising expiry data and a reference to the message, appending the list element to an expiry list, periodically deleting list elements from the expiry list that correspond to consumed messages and transferring list elements that correspond to unconsumed messages from the expiry list to a time sorted expiry index, and traversing the expiry index deleting those messages that have expired.

### TECHNICAL FIELD

This invention relates to a messaging system, and to a method of operating a messaging system.

### BACKGROUND OF THE INVENTION

A messaging system comprises a number of messaging engines in communication with one another. The engines communicate by sending messages, which will typically include data and/or requests for data or processes to be executed. A typical messaging system would be used for example, with respect to a commercial website, with different messaging engines for tasks such as maintaining a database of customers, for processing financial information, and for processing stock information. When a consumer accesses the website to place an order, a message may travel to the engine maintaining stock data to check on stock availability and likewise a request to update the consumer's account information may be transmitted to a different engine and so on under the control of messaging software.

In messaging systems it is a common requirement that the messaging software being run by the engines within the messaging system detect and delete “expired” messages. In general, this works as follows. A program that originates a message can specify a time-to-live, usually a number of milliseconds for the message, although some messaging software may allow this value to be overridden by rules. The expiry time for a particular message can be calculated by adding the time-to-live to the time the message was sent. This, or equivalent information, is carried with the message so that when the message has been delivered to a different computer system from the originator, the expiry time can be calculated by messaging software.

Several methods are known for ways that messaging software can handle expiry. For example, when a message is requested by a consumer (another engine), the messaging software can check to see if the first available message has expired. If it has, the messaging software discards that message and checks the next message in the queue. This method has a number of disadvantages because expired messages are only discarded when a consumer attempts to retrieve them. If there is no active consumer then messages do not expire. These messages needlessly use storage and other resources. In addition, the producer may be waiting for an expiry report message to be generated by the messaging software and returned to the producer. This report message can be delayed indefinitely if there is no active consumer.

A second known method is for the messaging software periodically to check all messages and identify and discard any that have expired. For example, U.S. Pat. No. 6,442,600 discloses a system for distributing electronic messages in an efficient manner using centralized storage and management. In particular, the system receives electronic messages to be distributed to one or more recipients, centrally stores a single copy of the message as well as various information about sending the message, and sends to each recipient a short indicator message to notify the recipient that the electronic message is available. The system then tracks and manages requests from the recipients to access the message by permitting access when appropriate, performing activities such as decrypting/encrypting the message if necessary, recording information about the access and about recipient instructions related to the message, archiving the message if necessary, and deleting the message when it is no longer needed. After a recipient receives an indicator, the recipient can use the indicator to access and review the message. The recipient can also provide various instructions about actions to be taken with the message corresponding to an indicator, such as to save or delete the message or to forward the message to another recipient. After all recipients have reviewed the message and no recipient has currently indicated to save the message (or all have indicated to delete the message), the system can then delete the single copy of the message. A message tracking table is maintained that includes the time that the message was sent, and the expiration time for each message. This allows the messaging software to identify and delete expired messages.

This method has disadvantages because processor resource (a finite amount for each message) is consumed for messages that have not expired. Most messages do not expire so that most of this resource is wasted.

A further method of handling message expiry is disclosed in U.S. Pat. No. 6,058,389. This patent discloses an advanced message queuing system that is integrated into a database system. A queue is an ordered list of messages. Messages are requests for processing by an application. Messages are database objects and can represent events or data. Messages comprise user data and control information such as a queue name. Each queue is part of a table in a relational database. A queue table holds a set of queues. Dictionary tables store configuration information describing queues and queue tables. Messages are entered into a queue by instructing the database system using an enqueuing command attached to a message and control information. The control information describes how to order, schedule, and execute the message, and can include a result queue name into which a result message is written after execution. The system responds to a dequeuing command by delivering a copy of a message from the queue. A user can define message order within a queue, message delay factors, and exception processing. Messages may be retained in their queues after delivery and can be preserved, queried, documented, correlated, reviewed and tracked, alone or in a set comprising a transaction, regardless of message state or execution state. The system can be used to develop large-scale, message-oriented distributed applications. Existing development tools for database applications can also be used to develop queuing applications. Administrative functions to create, delete, and specify access control for queues are provided. The system provides transactional integrity; a single transaction applies to both the database and the queue. A single transaction log is maintained.

Columns 28 and 29 of this U.S. Pat. No. 6,058,389 disclose a Time Manager process, one of the functions of which is to manage deletion of expired messages. The Time Manager, as one of its functions, maintains a timetable of messages (item 216 in the patent). When a message has an expiration parameter, it is inserted into this timetable. Whenever a row is written into the timetable, the Time Manager reads all of the entries in the timetable to locate the message row with the least time value. The Time Manager sets an alarm variable equal to that least time value. The Time Manager then tests whether the alarm value is equal to the system clock time, and if it is, it begins substantive processing. This processing involves locating a row in the timetable having a time value equal to the alarm time, and if its expiration value is null, then it is deleted.

The process described in this patent is computationally very complicated, requiring the Time Manager to repeatedly scan the timetable every time a message has an expiration parameter, and requiring the Time Manager to continually set alarm variables. When an alarm variable causes the Time Manager to begin processing, it must once again scan the whole timetable. Likewise the storage requirements of this methodology are not at a minimum.

### SUMMARY OF THE INVENTION

According to a first aspect of the present invention, there is provided a method of operating a messaging system comprising receiving a message, creating a list element for the message, the list element comprising expiry data and a reference to the message, appending the list element to an expiry list, periodically deleting list elements from the expiry list that correspond to consumed messages and transferring list elements that correspond to unconsumed messages from the expiry list to a time sorted expiry index, and traversing the expiry index deleting those messages that have expired.

According to a second aspect of the present invention, there is provided a messaging system comprising a plurality of messaging engines, each messaging engine comprising a processor and a communication interface for communicating with other messaging engines, at least one of the messaging engines arranged to receive a message, to create a list element for the message, the list element comprising expiry data and a reference to the message, to append the list element to an expiry list, to periodically delete list elements from the expiry list that correspond to consumed messages and to transfer list elements that correspond to unconsumed messages from the expiry list to a time sorted expiry index, and to traverse the expiry index deleting those messages that have expired.

According to a third aspect of the present invention, there is provided a computer program product on a computer readable medium for controlling a data processing system, the computer program product comprising instructions for operating a messaging system comprising receiving a message, creating a list element for the message, the list element comprising expiry data and a reference to the message, appending the list element to an expiry list, periodically deleting list elements from the expiry list that correspond to consumed messages and transferring list elements that correspond to unconsumed messages from the expiry list to a time sorted expiry index, and traversing the expiry index deleting those messages that have expired.

Owing to the invention, it is possible to operate a messaging system that will handle the expiration of messages in such away that a minimum of processing resources are used during the deletion of expired messages, without overly using storage resources for the undeleted messages. In this system, expired messages are preferably discarded even if there is no active consumer, and resources are not wasted by checking messages that have not expired.

The present invention comprises the core idea that the messaging software run by the messaging system maintains a list of messages sorted in order of expiry time. This is the expiry index. As each message arrives, its expiry time is computed and a list element is constructed. The list element comprises a pointer to the message and the message's expiry time.

However, the messaging software does not insert the list element into the expiry index when the message arrives. Instead, it appends the list element at the end of a simple unsorted list. This unsorted list is the expiry list. The messaging software includes an “expiry daemon” that processes the expiry list. It deletes list elements for already-consumed messages and moves any remaining list elements (for not yet consumed messages) into the expiry index.

Finally the expiry daemon traverses the expiry index. The daemon periodically traverses the expiry index. It preferably starts at the end corresponding to the earliest expiry time and proceeds in the direction of later expiry time. In this way, the messaging software can identify and discard any expired messages. The traverse preferably stops when the first not-expired message is encountered.

Appending list elements to a simple list (the expiry list) is much simpler and faster than inserting into an ordered list (the expiry index). Some messages will be consumed before the expiry daemon processes the expiry list. The cost of inserting these list entries into the expiry index is avoided. Also, in multithreading environments, the messaging software does not need complex locking to allow (or prevent) the expiry daemon processing the expiry index from executing in parallel with message arrival processing. It does need such locking to allow (or prevent) the expiry daemon processing of the expiry list executing in parallel with message arrival processing, but processing the expiry list is much simpler and faster than processing the expiry index; hence locking is much simpler and less disruptive. Also, handling transactional message arrival processing is much simplified.

Advantageously, the method preferably further comprises, while periodically deleting list elements from the expiry list that correspond to consumed messages and transferring list elements that correspond to unconsumed messages from the expiry list to a time sorted expiry index, closing the expiry list and appending any new list elements to a second expiry list.

Therefore, the messaging software preferably uses two expiry lists. Message arrival processing adds list elements to the “active” expiry list. When the expiry daemon runs, it allocates a new active expiry list before it processes the previously active (now “pending”) expiry list. The extent of locking required allowing (or preventing) the expiry daemon executing parallel with message arrival processing is reduced. Locking is only required while the new active expiry list is instated.

Preferably, the method further comprises maintaining a data packet comprising information on each expiry list. Effectively, a list of expiry lists is used. As above, message arrival processing adds list elements to the active expiry list. Periodically, a new active expiry list is allocated and the previous active list becomes a “maturing” expiry list. This is regarded as “promoting” the active expiry list. When the expiry daemon runs, it processes the oldest maturing expiry list.

Ideally, the method further comprises closing the current expiry list when a defined condition is met, and opening a new expiry list. The defined condition can comprise the number of list elements in the current expiry list exceeding a predetermined threshold, or the defined condition may comprise the expiration of a predetermined time period.

There are various ways that the messaging software can use to decide when to promote the active expiry list. These include, fixed size expiry lists can be used. In this case, promotion can be performed by message arrival processing when the active expiry list is full, or variable size expiry lists can be used. In this case, promotion can be done by the expiry daemon when it runs. This has the advantage that the introducing of maturing expiry lists allows extra time between adding entries to the active expiry list and processing those entries. This allows more time for the messages to be consumed and so reduces the number of list elements than need inserting into the expiry index.

Advantageously, the step of traversing the expiry index deleting those messages that have expired occurs periodically. This can occur following the expiration of a predetermined time period or following the detection that the size of the expiry lists and expiry index have exceeded a predetermined threshold.

The messaging software does not have to simply run the expiry daemon at regular time intervals. Instead, it can run the expiry daemon either when an appropriate time has elapsed since the last run, or when the storage occupied by the expiry lists and the expiry index exceeds some predetermined or dynamically computed amount, whichever occurs soonest. If the daemon is activated by excess storage usage, it does not terminate its scan of the expiry index when it encounters a not-expired message, but continues checking for and deleting entries for already consumed messages. With this refinement, the messaging software can minimize the amount of storage used by the expiry system.

### BRIEF DESCRIPTION OF THE DRAWING

Embodiments of the present invention will now be described, by way of example only, with reference to the accompanying drawings, in which:

FIG. 1 is a schematic diagram of a messaging system including a message,

FIG. 2 is a schematic diagram of the message of FIG. 1 and a corresponding list element,

FIG. 3 is a schematic diagram of the list element of FIG. 2 being appended to an expiry list,

FIG. 4 is a schematic diagram of the expiry list of FIG. 3 being used to generate an expiry index,

FIG. 5 is a schematic diagram of the expiry index of FIG. 4 being traversed to delete expired messages,

FIG. 6 is a schematic diagram of a pair of expiry lists, and

FIG. 7 is a schematic diagram of a data packet comprising information on the expiry lists of FIG. 6.

### DETAILED DESCRIPTION

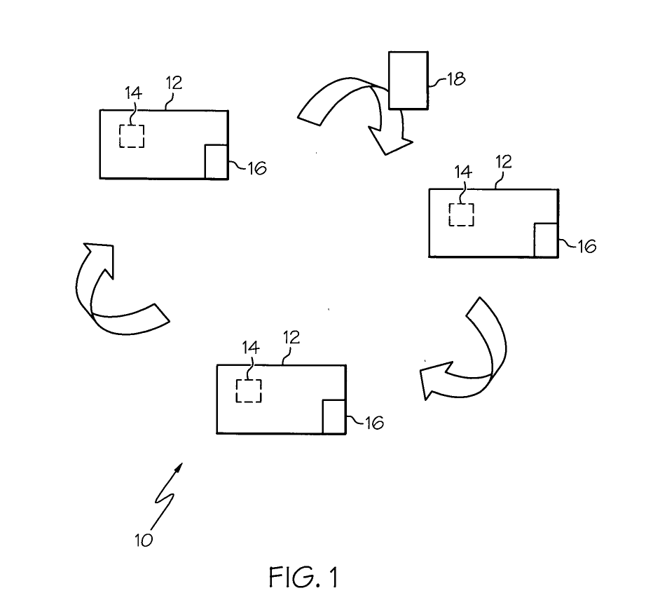

In FIG. 1, a messaging system 10 comprising a plurality of messaging engines 12 is shown. Each messaging engine 12 comprises a processor 14 and a communication interface 16 for communicating with the other messaging engines 12. A message 18 is shown, and each of the messaging engines 12 in the messaging system 10 can temporarily store messages awaiting consumption, or awaiting forwarding to another messaging engine. For simplicity, these two types of temporary storage can be considered to be equivalent and the term consumption means either delivery of the message to its ultimate consumer or forwarding the message to another messaging engine.

Each messaging engine 12 maintains those messages that are pending consumption in collections. The type of collection is selected to facilitate delivery of messages in the manner (for example in the order) required by the consuming messaging engine 12. Each of the engines in the system will run messaging software, which might use different types of collection for different aggregations of messages.

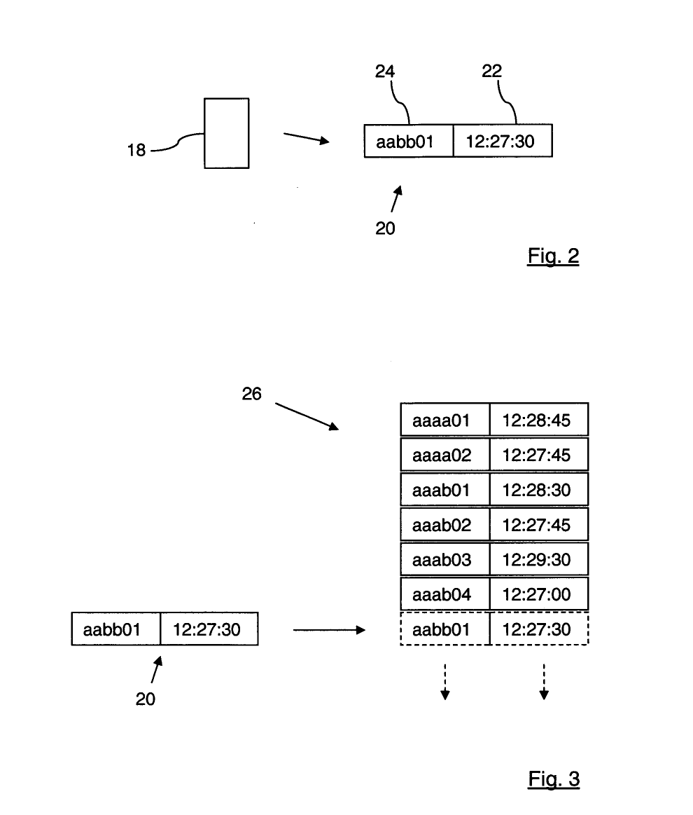

Each message carries with it, as metadata, its remaining time-to-live. The messaging software (run by the processor 14) of a messaging engine 12, upon receipt of a message 18, will create a list engine 20 for the message 18. This is illustrated in FIG. 2. The list element 20 comprises expiry data 22 and a reference 24 to the message 18.

The expiry data 22 comprises the time at which the message 18 is due to expire, which is computed by adding the time-to-live contained within the metadata of the message 18 to the time of the messaging system clock. For ease of understanding, the expiry data 22 is shown in FIG. 2 and subsequent Figures as a twenty four hour clock number of the form hh:mm:ss, although it will be appreciated that in reality, the expiry data 22 may be only a small number of milliseconds after the current time of the system clock, and will therefore record an expiry time to a large number of decimal places of a second.

In most messaging systems, some leeway is permitted in allowing messages to survive after their expiry time, although a timely deletion of expired messages is an advantage.

The reference 24 to the message 18 in FIG. 2 is the code “aabb01”, which identifies the message 18 in a unique manner. This reference 24 can be generated on the fly by the messaging software for each new message 18, or can be taken or computed form the metadata of the message. The reference 24 could alternatively be a location at which the message 18 can be found, being the form of a pointer or address of the message 18.

When a new list element 20 is generated by a messaging engine 12, it is appended to an expiry list 26, as shown in FIG. 3. The expiry list 26 is not ordered in any way, it is simply extended each time a new list element 20 is added. The expiry list 26 contains a series of list elements 20, all with unique references 24 to different messages 18, but with a variety of different expiry times 22, some of which may be the same time.

Once the list element 20 has been appended to the expiry list 26, further list elements 20 can be added in turn, as new messages 18 are received by the messaging engine 12 that is maintaining the expiry list 26. In the simplest embodiment of the invention, a single expiry list 26 is used and maintained for the purpose of deletion of expired messages 18. However more dynamic systems can use multiple expiry lists 26. This is discussed in further detail below.

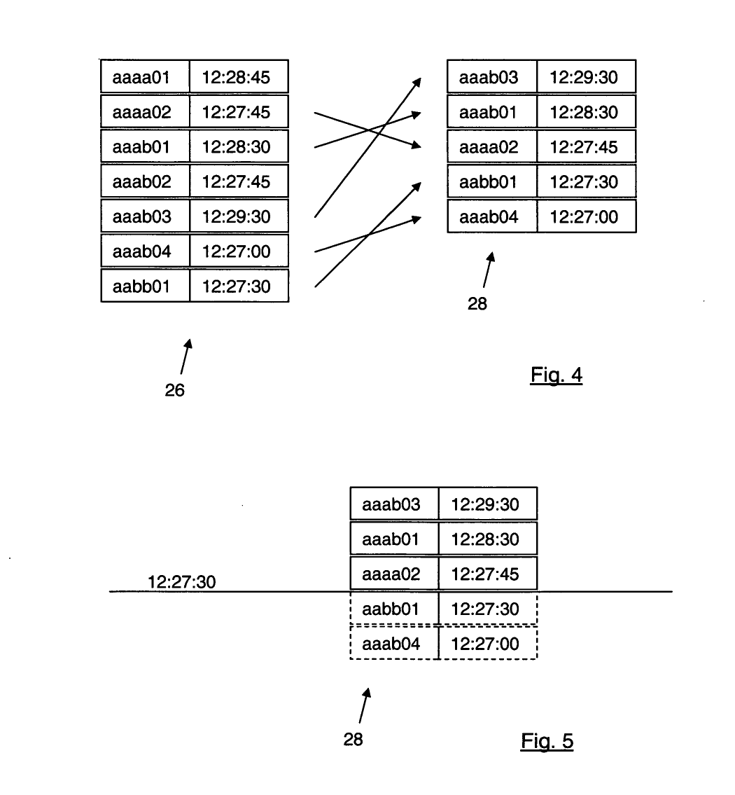

At a predefined point, the messaging engine 12 maintaining the expiry list 26 will run the expiry daemon over the expiry list 26 to generate an expiry index 28, as shown in FIG. 4. The trigger for creating the expiry index 28 can be based upon the expiration of a set period of time, or can be based upon number of list elements 20 in the expiry list 26 reaching a predefined number. The trigger for the creation of the expiry index 28 could also be based upon the availability of computational or storage resources.

To create the expiry index 28, the expiry daemon will delete list elements 20 from the expiry list 26 that correspond to consumed messages 18 and transfers the unconsumed messages 18 to the time sorted expiry index 28. When a message 18 is consumed by a messaging element 12, the element 12 will send an appropriate flag to the element 12 that is maintaining the expiry list 26. This results in the appropriate list element 20 being marked as relating to a consumed message 18, with the list element 20 for that consumed message 18 being deleted when the expiry daemon passes through the expiry list 26. In the example of FIG. 4, the messages that correspond to list element “aaaa01” and to list element “aaab02” have been consumed since the list elements 20 for these messages 18 were created. These list element 20 are therefore deleted from the expiry list 26 and do not appear in the expiry index 28.

The expiry index 28 is time ordered, based upon the times stored in the expiry data 22 of each list element 20. This time ordering of the expiry index 28 is to facilitate the ultimate deletion of those list elements 20 (and therefore their corresponding messages 18) that relate to messages 18 that have expired. The expiry daemon will periodically traverse the expiry index 28 deleting list elements 20.

In FIG. 5, at clock time 12:27:30, the expiry daemon is executing a traverse of the expiry index 28. The traverse will start at the list element 20 that has the earliest expiry time, in this case the list element “aaab04”, which has an expiry time of 12:27:00. Since the clock time is later than the expiry time of this list element 20, the list element “aaab04” is deleted, as well as the corresponding message 18. The expiry daemon then moves to the next list element “aabb01”, which with an expiry time of 12:27:30, is also deleted along with its corresponding message 20.

The daemon then moves to the list element “aaaa02”, which has an expiry time of 12:27:45, which is a later time than that indicated by the system clock. Since the clock time is earlier than the expiry time for this list element 20, then the software ceases the traverse of the expiry index 28 at this point. Since the expiry index is time-ordered, then when the expiry daemon has reached the first non-expired list element 20, it will be the case that no more list elements will have expired.

The messaging software may be required to generate an expiry report message as a response to the originator of the expired message, when it deletes the message. Whether or not an expiry report is generated, and where it is sent to, are typically specified by the message originator and carried with the message as metadata.

While the messaging software is periodically deleting list elements 20 from the expiry list 26 that correspond to consumed messages and transferring list elements 20 that correspond to unconsumed messages from the expiry list 26 to a time sorted expiry index 28, the messaging software will close the current expiry list 26. This closure, or locking, of the expiry list 26 is to ensure that errors of synchronisation do not occur while the expiry daemon is traversing the expiry index 28.

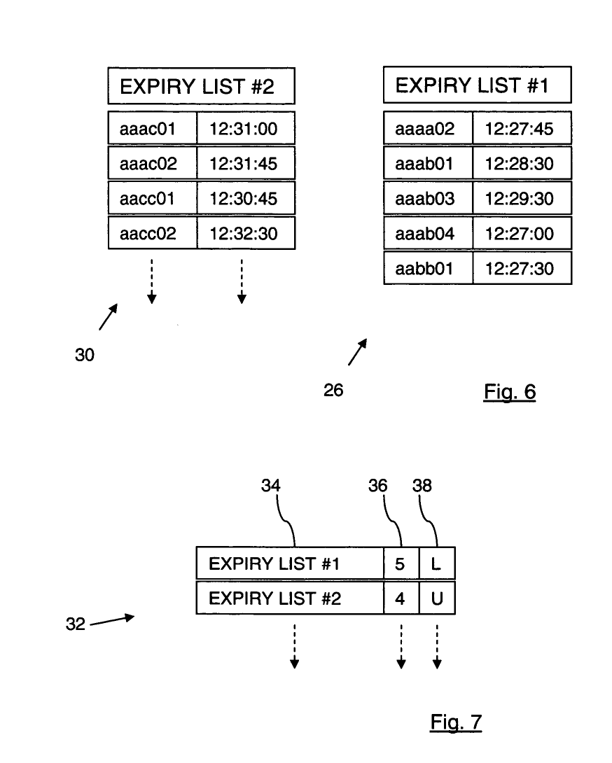

Since the messaging engines 12 will still be operating while the messaging software is dealing with the deletion of expired messages, new messages 18 will be generated. As a result of the generation of messages, new list elements 20 will continue to be created. While the first expiry list 26 is locked for the processing of this list 26 into the index 28, any new list elements are append to a second expiry list 30, shown in FIG. 6. The new expiry list 30 is structured in exactly the same manner as the old list 26, with new list elements 20 being added to the bottom of this expiry list 30, as new messages 18 are received by a messaging engine.

To keep track of the expiry lists 26 and 30, the messaging software maintains a data packet 32, shown in FIG. 7, which comprises information on each expiry list 26 and 30. The data packet 32 has three columns of data for each expiry list, being a first column 34 that consists of the name of the expiry list, a second column 36 that contains a numerical value of the number of list elements in that expiry list, and a third column 28 that contains a flag indicating whether that expiry list is locked (L) or unlocked (U).

Although the use of a second expiry list 30 is described above as being created when a traverse is being made of a locked expiry list to create an expiry index, the closing of one expiry list and opening of a new expiry list could be based upon other considerations. For example, a new expiry list could be opened when the number of list elements in the current expiry list exceeds a predetermined threshold, or after the expiration of a predetermined time period.

In a typical messaging system, the messaging software will be implemented using Java™ (Java and all Java-based trademarks and logos are trademarks of Sun Microsystems, Inc. in the United States, other countries, or both), with each messaging engine 12 maintaining a variable size list of fixed-size expiry lists 26. These lists are used for all messages stored in the messaging engine and are not specific to particular aggregates of messages. The messaging engine 12 also maintains one expiry index 28. The expiry index is a generalized binary search (GBS) tree. This type of tree is efficient for insertion and deletion of elements when there is a strong underlying sequential pattern to the inserts and deletes. Information on GBS trees can be found in the following documents, which are incorporated herein by reference: “The Art of Computer Programming” by Donald E. Knuth, Volume 3, Sorting and Searching, Second Edition (Reading, Mass.: Addison-Wesley, 1998), ISBN 0-201-89685-0, “A Study of Index Structures for Main Memory Database Management Systems” by Tobin J. Lehman and Michael J. Carey (Morgan Kaufmann, 1986), ISBN 0-934613-18-4, and “Improving Time and Space Efficiency in Generalized Binary Search Trees” by Walter Cunto and Jose Luis Gascon (Springer-verlag 1987), from the journal “Acta Informatica”, volume 24.

When the message 18 arrives at the messaging engine 12, the messaging engine 12 computes the expiry time and constructs a list element 20 that comprises a Java weak reference to the message 18 and the expiry time. It adds that element 20 to the end of the currently active expiry list 26. Adding the element 20 is synchronized against other additions and against changing to a new active list. When a message 18 is consumed, the message 18 is so marked. In due course the Java garbage collection will delete the message object and invalidate weak references to it.

If adding the list element 20 fills the active list, a new active list is allocated and the previous active list becomes a maturing list. If the total number of expiry lists now exceeds a predefined limit, the expiry daemon is activated (unless it is already active). Independently of this processing, the expiry daemon is activated if a predefined amount of time has elapsed since the last activation. Well known techniques are used to ensure that there is only ever one instance of the expiry daemon running at one time.

The expiry daemon processes the oldest maturing expiry list. If there are no maturing expiry lists, the demon allocates a new active list and processes the previous active (now maturing) list. This ensure timely expiry even when few new messages are arriving. Processing the maturing expiry list comprises inspecting each element. If the weak reference has been invalidated, the message has been consumed and the list element is discarded. Otherwise the message is inspected. If marked “consumed,” the list element is discarded. Otherwise the list element is inserted into the expiry index. When all entries have been processed, the list is discarded.

The daemon then scans the expiry index, as described in the summary above. List elements for consumed messages (identified as just described) are discarded. List elements for expired messages are handled by deletion of the message and then discarding the list element. The manipulation of the expiry index, including the inserting and deleting of elements, and rebalancing the GBS tree, can be done without locking of the expiry list since there is only ever one active expiry daemon.

We claim:

1. A method of operating a messaging system comprising receiving a message, creating a list element for the message, the list element comprising expiry data and a reference to the message, appending the list element to an expiry list, periodically deleting list elements from the expiry list that correspond to consumed messages and transferring list elements that correspond to unconsumed messages from the expiry list to a time sorted expiry index, and traversing the expiry index deleting those messages that have expired.

2. A method according to claim 1, and further comprising, while periodically deleting list elements from the expiry list that correspond to consumed messages and transferring list elements that correspond to unconsumed messages from the expiry list to a time sorted expiry index, closing the expiry list and appending any new list elements to a second expiry list.

3. A method according to claim 1, and further comprising closing the current expiry list when a defined condition is met, and opening a new expiry list.

4. A method according to claim 3, wherein the defined condition comprises the number of list elements in the current expiry list exceeding a predetermined threshold.

5. A method according to claim 3, wherein the defined condition comprises the expiration of a predetermined time period.

6. A method according to claim 1, wherein the step of traversing the expiry index deleting those messages that have expired occurs periodically.

7. A messaging system comprising a plurality of messaging engines, each messaging engine comprising a processor and a communication interface for communicating with other messaging engines, at least one of the messaging engines arranged to receive a message, to create a list element for the message, the list element comprising expiry data and a reference to the message, to append the list element to an expiry list, to periodically delete list elements from the expiry list that correspond to consumed messages and to transfer list elements that correspond to unconsumed messages from the expiry list to a time sorted expiry index, and to traverse the expiry index deleting those messages that have expired.

8. A system according to claim 7, wherein the messaging engine is further arranged, while periodically deleting list elements from the expiry list that correspond to consumed messages and transferring list elements that correspond to unconsumed messages from the expiry list to a time sorted expiry index, to close the expiry list and to append any new list elements to a second expiry list.

9. A system according to claim 7, wherein the messaging engine is further arranged to close the current expiry list when a defined condition is met, and to open a new expiry list.

10. A system according to claim 9, wherein the defined condition comprises the number of list elements in the current expiry list exceeding a predetermined threshold.

11. A system according to claim 9, wherein the defined condition comprises the expiration of a predetermined time period.

12. A system according to claim 7, wherein the messaging engine is arranged so that the traverse of the expiry index to delete those messages that have expired occurs periodically.

13. A system according to claim 12, wherein the messaging engine is arranged so that the periodical traverse of the expiry index to delete those messages that have expired occurs following the expiration of a predetermined time period.

14. A computer program product on a computer readable medium for controlling a data processing system, the computer program product comprising instructions for operating a messaging system comprising receiving a message, creating a list element for the message, the list element comprising expiry data and a reference to the message, appending the list element to an expiry list, periodically deleting list elements from the expiry list that correspond to consumed messages and transferring list elements that correspond to unconsumed messages from the expiry list to a time sorted expiry index, and traversing the expiry index deleting those messages that have expired.

15. A computer program product according to claim 14, and further comprising instructions, while periodically deleting list elements from the expiry list that correspond to consumed messages and transferring list elements that correspond to unconsumed messages from the expiry list to a time sorted expiry index, for closing the expiry list and for appending any new list elements to a second expiry list.

16. A computer program product according to claim 14, and further comprising instructions for closing the current expiry list when a defined condition is met, and for opening a new expiry list.

17. A computer program product according to claim 16, wherein the defined condition comprises the number of list elements in the current expiry list exceeding a predetermined threshold.

18. A computer program product according to claim 16, wherein the defined condition comprises the expiration of a predetermined time period.

19. A computer program product according to claim 14, wherein the step of traversing the expiry index deleting those messages that have expired occurs periodically.

20. A computer program product according to claim 19, wherein the step of periodically traversing the expiry index deleting those messages that have expired occurs following the detection that the size of the expiry lists and expiry index have exceeded a predetermined threshold.
